(19) United States
(12) Patent Application Publication
(10) Pub. No.: US 2025/0164068 A1
(43) Pub. Date: May 22, 2025

(54) FIXATION STRUCTURE

(71) Applicant: Wistron NeWeb Corporation, Hsinchu (TW)

(72) Inventors: Chung-Hau WANG, Hsinchu (TW); Ting-Shiang CHIU, Hsinchu (TW)

(21) Appl. No.: 18/954,769

(22) Filed: Nov. 21, 2024

(30) Foreign Application Priority Data
Nov. 22, 2023 (TW) 112145148

(51) Int. Cl. F16M 13/02; H01F 7/02; H01F 7/04

(52) U.S. Cl. CPC F16M 13/02; H01F 7/0252; H01F 7/04

(57) ABSTRACT

A fixation structure includes a first device body and a second device body. The first device body includes a first magnetic unit. The second device body is detachably and magnetically connected to the first device body, and the second device body includes a second magnetic unit and a third magnetic unit. The second magnetic unit is detachably and magnetically connected to the first magnetic unit. The third magnetic unit is pivotally disposed on the second magnetic unit, and the second magnetic unit is located between the first device body and the third magnetic unit.

### RELATED APPLICATIONS

This application claims the benefit of priority to Taiwan Patent Application No. 112145148, filed on Nov. 22, 2023. The entire content of the above identified application is incorporated herein by reference.

### BACKGROUND

### Technical Field

The present disclosure relates to a fixation structure, and more particularly, the present disclosure relates to a fixation structure that can be easily and quickly installed onto a load-bearing structure and can be easily and quickly removed from it.

### Description of Related Art

With the widespread popularity of the internet and 3C technology products, the demand for customer-premises equipment (CPE) in the current market is increasing, and the installation requirements for CPE are also becoming more important.

The current installation methods for CPE often require the use of screws, nails, and other components with tools to install them onto load-bearing structures, such as panels, walls, windows, and columns. However, the use of tools is complicated for general users, and the positioning of the equipment on the load-bearing structure with screws, nails or other components can destroy the load-bearing structure. Thus, the appearance of the load-bearing structure can be damaged, and the overall structural strength thereof can be affected. Furthermore, if there is a large gap between the CPE and the load-bearing structure, or if the installation technique is not applied properly, the installation stability of the CPE cannot be as stable as expected, and there can even be a risk of it falling off during use.

In view of this, there is an urgent need in the current market for a fixation structure that can be easily and quickly installed onto a load-bearing structure and with a simplified installation process so as to meet the installation requirements of various devices.

### SUMMARY

According to one aspect of the present disclosure, a fixation structure includes a first device body and a second device body. The first device body includes a first magnetic unit. The second device body is detachably and magnetically connected to the first device body, and the second device body includes a second magnetic unit and a third magnetic unit. The second magnetic unit is detachably and magnetically connected to the first magnetic unit. The third magnetic unit is pivotally disposed on the second magnetic unit. The second magnetic unit and the third magnetic unit abut against each other, and the second magnetic unit is located between the first device body and the third magnetic unit. The first device body is oriented with the first magnetic unit facing a surface of a load-bearing structure, and the second device body is oriented with the second magnetic unit facing another surface opposite the surface of the load-bearing structure, so that the first device body and the second device body are respectively positioned on two sides of the load-bearing structure, and a magnetic attraction force is generated between the first magnetic unit and the second magnetic unit to magnetically connect the first device body to the second device body so as to position the fixation structure on the load-bearing structure. The third magnetic unit is pivoted relative to the second magnetic unit so as to adjust the magnetic attraction force between the first magnetic unit and the second magnetic unit.

According to another aspect of the present disclosure, a fixation structure includes a first device body and a second device body. The first device body includes a first magnetic unit. The second device body is detachably and magnetically connected to the first device body, and the second device body includes a carrier body, a casing, a second magnetic unit, a third magnetic unit and an adjustment member. The carrier body includes a guiding slot. The casing is coupled to the carrier body and includes an engaging slot. An accommodation space is defined by the casing and the carrier body, and the guiding slot and the engaging slot are communicated with each other so as to form an adjustment structure. The second magnetic unit is disposed on the carrier body and located in the accommodation space, and the second magnetic unit is detachably and magnetically connected to the first magnetic unit. The third magnetic unit is pivotally disposed on the second magnetic unit and located in the accommodation space. The second magnetic unit is located between the first device body and the third magnetic unit, and a component gap is defined between the second magnetic unit and the third magnetic unit. The adjustment member is fixed on the third magnetic unit. The adjustment member protrudes from the accommodation space and is movably engaged in the adjustment structure. The first device body is oriented with the first magnetic unit facing a surface of a load-bearing structure, and the second device body is oriented with the second magnetic unit facing another surface opposite the surface of the load-bearing structure, so that the first device body and the second device body are respectively positioned on two sides of the load-bearing structure, and a magnetic attraction force is generated between the first magnetic unit and the second magnetic unit to magnetically connect the first device body to the second device body so as to position the fixation structure on the load-bearing structure. When the adjustment member moves in the adjustment structure, the third magnetic unit moves relative to the second magnetic unit so as to adjust the magnetic attraction force between the first magnetic unit and the second magnetic unit.

### BRIEF DESCRIPTION OF THE DRAWINGS

The present disclosure can be more fully understood by reading the following detailed description of the embodiment, with reference made to the accompanying drawings as follows:

FIG. 1 is a schematic view of a fixation structure according to one embodiment of the present disclosure.

FIG. 2 is another schematic view of the fixation structure shown in FIG. 1.

FIG. 3 is an exploded view of a first device body of the fixation structure shown in FIG. 1.

FIG. 4 is an exploded view of a second device body of the fixation structure shown in FIG. 1.

FIG. 5 is an exploded view of a second magnetic unit and a third magnetic unit of the second device body shown in FIG. 4.

FIG. 6A is a schematic view of a magnetic pole arrangement of the fixation structure shown in FIG. 1 when a magnetic attraction force between the first device body and the second device body is in a weak magnetic state.

FIG. 6B is a schematic view of a magnetic pole arrangement of the fixation structure shown in FIG. 1 when the magnetic attraction force between the first device body and the second device body is in a strong magnetic state.

FIG. 6C is a schematic view of a magnetic pole arrangement of the fixation structure shown in FIG. 1 when the magnetic attraction force between the first device body and the second device body is released.

FIG. 7 is a schematic view of the fixation structure shown in FIG. 1 applied to a load-bearing structure.

FIG. 8 is a schematic view of a fixation structure according to another embodiment of the present disclosure.

FIG. 9 is an exploded view of a second device body of the fixation structure shown in FIG. 8.

FIG. 10 is an exploded view of a second magnetic unit and a third magnetic unit of the second device body shown in FIG. 9.

FIG. 11 is a schematic view of a fixation structure according to yet another embodiment of the present disclosure.

FIG. 12 is an exploded view of a second device body of the fixation structure shown in FIG. 11.

FIG. 13A is an operational schematic view of the fixation structure shown in FIG. 11 applied to a load-bearing structure.

FIG. 13B is another operational schematic view of the fixation structure shown in FIG. 11 applied to the load-bearing structure.

FIG. 13C is yet another operational schematic view of the fixation structure shown in FIG. 11 applied to the load-bearing structure.

FIG. 14 is a cross-sectional view of the second device body of the fixation structure shown in FIG. 13C.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

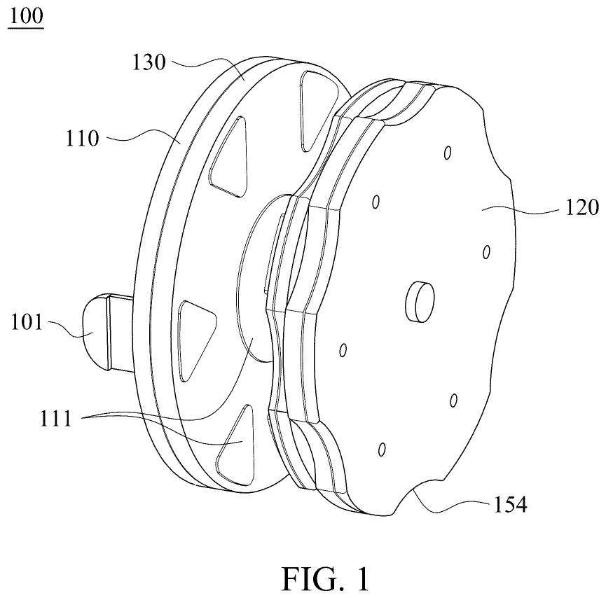

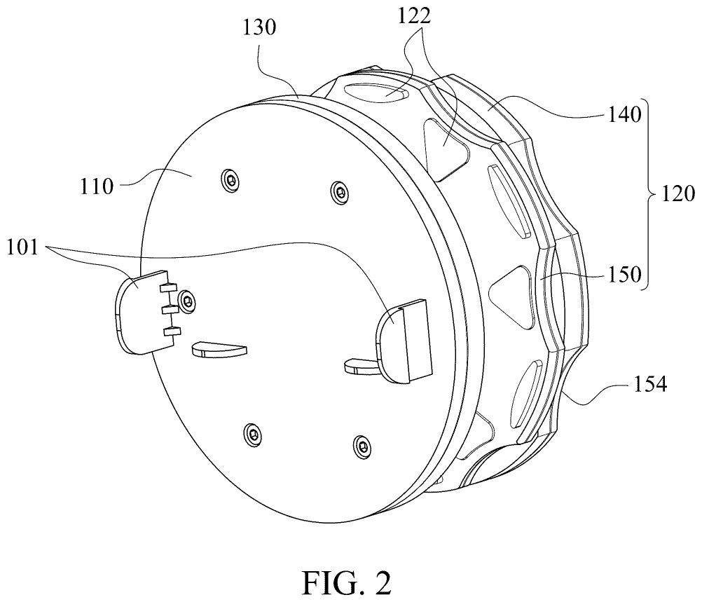

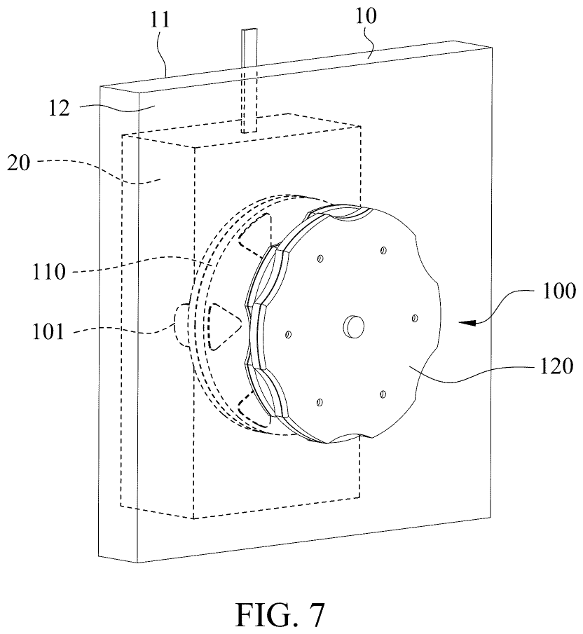

Reference is made to FIG. 1 and FIG. 2, FIG. 1 is a schematic view of a fixation structure 100 according to one embodiment of the present disclosure, and FIG. 2 is another schematic view of the fixation structure 100 shown in FIG. 1. The fixation structure 100 is positioned on a load-bearing structure 10 (shown in FIG. 7) to fix carried objects such as an electronic device 20 (shown in FIG. 7) onto the load-bearing structure 10. The load-bearing structure 10 can be a structure with open spaces on both sides, such as panels, walls, windows, columns, etc., and the fixation structure 100 includes a first device body 110 and a second device body 120. Further, the fixation structure 100 can be an installation bracket for the customer-premises equipment (CPE) so as to meet the increasing demand for the CPE.

The first device body 110 includes a first magnetic unit 130. The second device body 120 is detachably and magnetically connected to the first device body 110, and the second device body 120 includes a second magnetic unit 140 and a third magnetic unit 150. The second magnetic unit 140 is detachably and magnetically connected to the first magnetic unit 130, and the third magnetic unit 150 is pivotally disposed on the second magnetic unit 140. The second magnetic unit 140 and the third magnetic unit 150 abut against each other, and the second magnetic unit 140 is located between the first device body 110 and the third magnetic unit 150. Specifically, the first device body 110 and the second device body 120 will be attracted or repelled to each other due to the different magnetic states between the first magnetic unit 130, the second magnetic unit 140 and the third magnetic unit 150, allowing the first device body 110 and the second device body 120 to be detachably and magnetically connected.

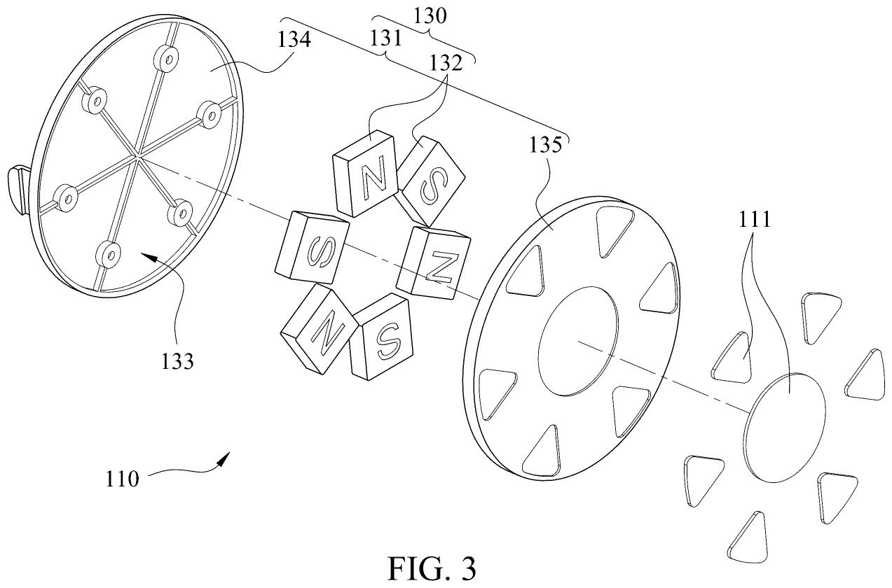

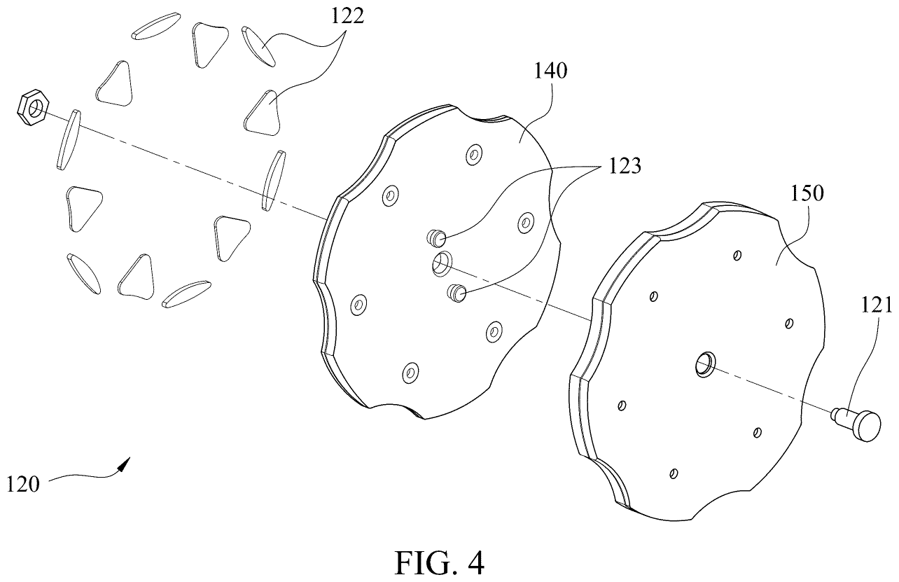

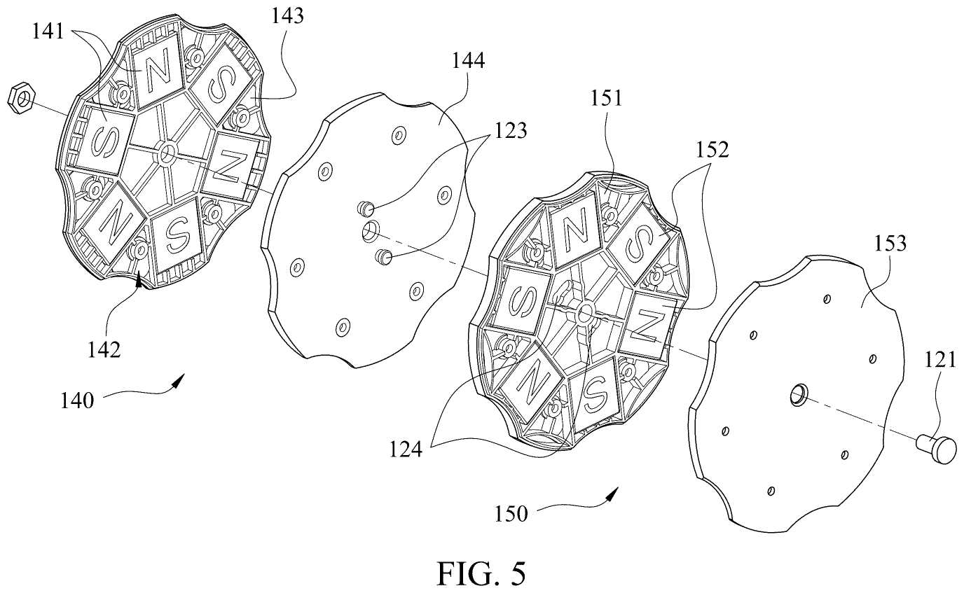

Reference is made to FIG. 1, FIG. 2, FIG. 3, FIG. 4, and FIG. 5 simultaneously. FIG. 3 is an exploded view of the first device body 110 of the fixation structure 100 shown in FIG. 1, FIG. 4 is an exploded view of the second device body 120 of the fixation structure 100 shown in FIG. 1, and FIG. 5 is an exploded view of the second magnetic unit 140 and the third magnetic unit 150 of the second device body 120 shown in FIG. 4.

As shown in FIG. 3, the first magnetic unit 130 of the first device body 110 includes a housing 131 and at least two first magnets 132. The housing 131 has an internal space 133, and the at least two first magnets 132 are disposed in the internal space 133. Specifically, the housing 131 can include a first housing element 134 and a second housing element 135, the first housing element 134 and the second housing element 135 are coupled to each other and define the internal space 133, and the first magnets 132 disposed in the internal space 133 are separated from each other and arranged around a central point (not shown) of the first device body 110. Furthermore, in the fixation structure 100, the housing 131 is a disc-shaped housing, wherein one of the first magnets 132 is disposed in the housing 131 with one magnetic pole (north pole or south pole) thereof facing outward, another one of the first magnets 132 disposed adjacent to the one of the first magnets 132 is also disposed in the housing 131 with one magnetic pole thereof facing outward, but the magnetic poles of any of the two first magnets 132 adjacent thereto are arranged in opposite polarities when viewed from a disc surface direction of the housing 131. For example, when one of the first magnets 132 is disposed on the first housing element 134 with the north pole thereof facing outward, other two of the first magnets 132 adjacent to the one of the first magnets 132 will be disposed on the first housing element 134 with the south poles thereof facing outward, so that the at least two first magnets 132 of the first magnetic unit 130 are configured in an alternating arrangement of north poles and south poles as shown in FIG. 3.

In FIG. 3, a number of the first magnets 132 is six, but the present disclosure is not limited thereto. In other words, as long as the magnetic poles of the first magnets 132 can correspond to the magnetic poles of the second magnetic unit 140, the corresponding effect can be achieved.

As shown in FIG. 4 and FIG. 5, the second magnetic unit 140 and the third magnetic unit 150 of the second device body 120 are connected to each other by a pivoting member 121, so that the third magnetic unit 150 can be pivoted relative to the second magnetic unit 140.

The second magnetic unit 140 includes at least two second magnets 141, the at least two second magnets 141 are disposed in an inner space 142 of the second magnetic unit 140, and the at least two second magnets 141 are separated from each other and arranged around a central point (not shown) of the second device body 120. Specifically, the second magnetic unit 140 can include an installation disc 143 and a first cover element 144, the installation disc 143 and the first cover element 144 are coupled to each other and define the inner space 142, and the at least two second magnets 141 are fixed on the installation disc 143 and located in the inner space 142. As shown in FIG. 5, one of the second magnets 141 is disposed in the installation disc 143 with one magnetic pole (north pole or south pole) thereof facing outward, another one of the second magnets 141 disposed adjacent to the one of the second magnets 141 is also disposed in the installation disc 143 with one magnetic pole thereof facing outward, but the magnetic poles of any of the two second magnets 141 adjacent are arranged in opposite polarities when viewed from a disc surface direction of the installation disc 143. Therefore, the at least two second magnets 141 of the second magnetic unit 140 can be arranged corresponding to the arrangement of the magnetic poles configured alternately of north poles and south poles as shown in FIG. 5.

Furthermore, in the fixation structure 100, a number of second magnets 141 can be at least two, and can also be four, six, or other even numbers. In FIG. 5, the number of the second magnets 141 is six, but the present disclosure is not limited thereto.

The third magnetic unit 150 is pivoted relative to the second magnetic unit 140 so as to adjust the magnetic attraction force between the first magnetic unit 130 and the second magnetic unit 140. The third magnetic unit 150 includes a carrier plate 151 and at least one third magnet 152, and the at least one third magnet 152 is disposed on the carrier plate 151. Specifically, the third magnetic unit 150 can further include a second cover element 153, and the carrier plate 151 and the second cover element 153 are coupled to each other. The at least one third magnet 152 is fixed on the carrier plate 151 with one magnetic pole (north pole or south pole) thereof facing outward, so that one magnetic pole of the at least one third magnet 152 is proximate to the second magnetic unit 140, and the other magnetic pole of the at least one third magnet 152 is distal to the second magnetic unit 140.

Further, in the fixation structure 100, a number of third magnets 152 can be at least one or at least two, and the number of third magnets 152 can by six as shown in FIG. 5, but the present disclosure is not limited thereto. For example, when the number of the third magnets 152 is configured as more than two and is six as shown in FIG. 5, and the third magnetic unit 150 pivots relative to the second magnetic unit 140, the relative positions of the third magnets 152 and the at least two second magnets 141 can be adjusted. When one of the third magnets 152 and the second magnet 141 corresponding thereto attract to each other, the magnetic attraction force between the first magnetic unit 130 and the second magnetic unit 140 will be enhanced.

Furthermore, when the number of third magnets 152 is at least two, the third magnets 152 can be configured with the north poles thereof proximate to the second magnetic unit 140, with the south poles thereof proximate to the second magnetic unit 140, or with the north poles and the south poles thereof arranged alternately. However, the present disclosure is not limited thereto.

Furthermore, the first magnets 132, the second magnets 141, and the third magnets 152 can be permanent magnets. In addition to the rectangular as shown in FIG. 3 and FIG. 5, the shapes of the first magnets 132, the second magnets 141, and the third magnets 152 can also be circular, elliptical, triangular, or other shapes as needed, but the present disclosure is not limited thereto.

In the fixation structure 100, the second device body 120 can further include at least one sliding block 123 and at least one restricting slot 124. The at least one sliding block 123 is disposed on one of the second magnetic unit 140 and the third magnetic unit 150, and the at least one restricting slot 124 is disposed on another one of the second magnetic unit 140 and the third magnetic unit 150. For example, as shown in FIG. 4 and FIG. 5, the at least one sliding block 123 can be disposed on the second magnetic unit 140 and located on the surface (reference number thereof is omitted) of the first cover element 144 facing the carrier plate 151, and the at least one restricting slot 124 can be disposed on the third magnetic unit 150 and located on the surface (reference number thereof is omitted) of the carrier plate 151 facing the first cover element 144. When the third magnetic unit 150 is pivotally disposed on the second magnetic unit 140, the sliding block 123 is correspondingly restricted within the restricting slot 124, and when the third magnetic unit 150 pivots relative to the second magnetic unit 140, the sliding block 123 will slide within the restricting slot 124 so as to restrict the relative pivoting degree between the second magnetic unit 140 and the third magnetic unit 150. Therefore, it is favorable for adjusting the magnetic attraction force between the first device body 110 and the second device body 120, and the switching between the strong magnetic state and the weak magnetic state can be achieved.

Further, although not shown in the drawings, the sliding block can also be disposed on the surface of the carrier plate facing the first cover element, and the restricting slot can be disposed on the surface of the first cover element facing the carrier plate. The number of sliding blocks and restricting slots can be adjusted as needed, and the present disclosure is not limited to the disclosed content.

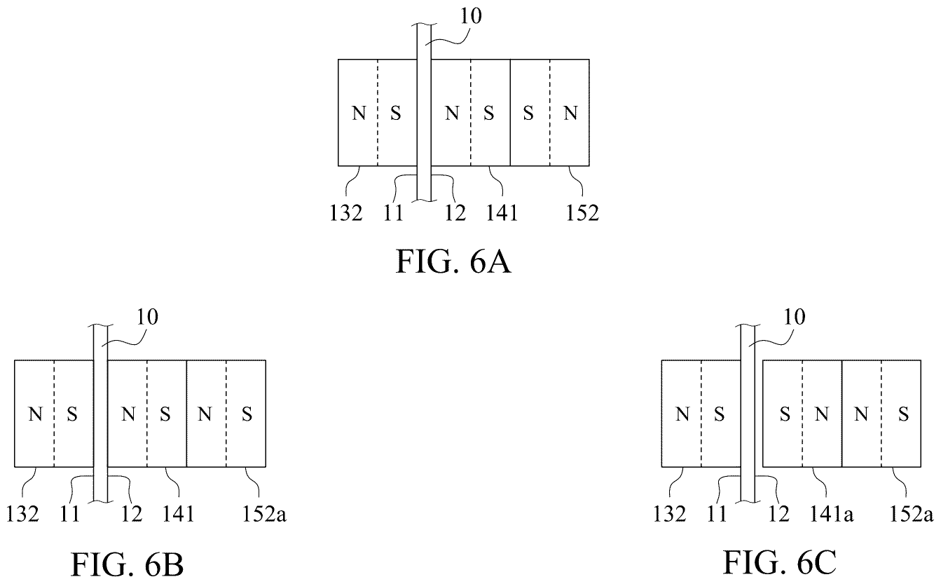

Reference is made to FIG. 1, FIG. 3, FIG. 5, FIG. 6A, FIG. 6B, and FIG. 6C simultaneously. FIG. 6A is a schematic view of the magnetic pole arrangement of the fixation structure 100 shown in FIG. 1 when the magnetic attraction force between the first device body 110 and the second device body 120 is in a weak magnetic state, FIG. 6B is a schematic view of the magnetic pole arrangement of the fixation structure 100 shown in FIG. 1 when the magnetic attraction force between the first device body 110 and the second device body 120 is in a strong magnetic state, and FIG. 6C is a schematic view of the magnetic pole arrangement of the fixation structure 100 shown in FIG. 1 when the magnetic attraction force between the first device body 110 and the second device body 120 is released.

For simplification, FIG. 6A only shows one of the first magnets 132 of the first magnetic unit 130, one of the second magnets 141 of the second magnetic unit 140, and one of the third magnets 152 of the third magnetic unit 150, and the aforementioned elements are shown in combination with the elements of FIG. 1, FIG. 3, and FIG. 5 so as to explain the variation of the magnetic attraction force when the first device body 110 and the second device body 120 are installed on the load-bearing structure 10. When the second magnetic unit 140 and the third magnetic unit 150 are pivoted relative to each other, the second magnet 141 and the third magnet 152 in FIG. 6A will be explained as the second magnet 141a and the third magnet 152a in FIG. 6B and FIG. 6C so as to emphasize the corresponding arrangement of different magnets after pivoting.

Specifically, in the fixation structure 100, the first device body 110 is oriented with the first magnetic unit 130 facing a surface 11 of the load-bearing structure 10, and the second device body 120 is oriented with the second magnetic unit 140 facing a surface 12 opposite the surface 11 of the load-bearing structure 10. At this time, a magnetic attraction force will be generated between the first magnetic unit 130 and the second magnetic unit 140, and the first device body 110 and the second device body 120 will be automatically aligned and magnetically connect to each other by the magnetic attraction force, so that the first device body 110 and the second device body 120 are respectively positioned on the two sides of the load-bearing structure 10 so as to position the fixation structure 100 on the load-bearing structure 10.

As shown in FIG. 1 and FIG. 6A, when the first device body 110 and the second device body 120 are automatically aligned and magnetically connected to each other, the first magnet 132, the second magnet 141 and the third magnet 152 will align to each other along a central axis direction of the fixation structure 100. At this time, the south pole of the first magnet 132 is proximate to the surface 11 of the load-bearing structure 10, while the north pole of the first magnet 132 is distal to the surface 11 of the load-bearing structure 10. Meanwhile, the north pole of the second magnet 141 is proximate to the surface 12 of the load-bearing structure 10, and the south pole of the second magnet 141 is distal to the surface 12 of the load-bearing structure 10. Further, the south pole of the third magnet 152 is proximate to the second magnet 141, and the north pole of the third magnet 152 is distal to the second magnet 141. When the first magnet 132, the second magnet 141 and the third magnet 152 are arranged as shown in FIG. 6A, the second magnet 141 and the third magnet 152 will repel to each other, so that the magnetic attraction force between the first device body 110 and the second device body 120 will present a weak magnetic state.

As shown in FIG. 1 and FIG. 6B, when the third magnetic unit 150 is pivoted relative to the second magnetic unit 140, the third magnet 152 shown in FIG. 6A will move away from the second magnet 141, and the third magnet 152a adjacent to the third magnet 152 will further move to align and correspond to the second magnet 141 along the central axis direction of the fixation structure 100. At this time, the north pole of the third magnet 152a is proximate to the south pole of the second magnet 141, and the south pole of the third magnet 152a is distal to the second magnet 141. Accordingly, the second magnet 141 and the third magnet 152a will attract to each other, the magnetic attraction force between the first magnetic unit 130 and the second magnetic unit 140 can be enhanced, and the magnetic attraction force there between will present a strong magnetic state.

As shown in FIG. 1 and FIG. 6C, when the fixation structure 100 is to be detached from the load-bearing structure 10, the second magnetic unit 140 is pivoted relative to the first device body 110. At this time, the second magnet 141 shown in FIG. 6B will move away from the first magnet 132, and the second magnet 141a adjacent to the second magnet 141 will further move to align and correspond to the first magnet 132 along the central axis direction of the fixation structure 100. Then, the south pole of the second magnet 141a is proximate to the surface 12 of the load-bearing structure 10, and the north pole of the second magnet 141a is distal to the surface 12 of the load-bearing structure 10. Simultaneously, the third magnet 152a and the second magnet 141a will correspond to each other along the central axis direction of the fixation structure 100, so that the north pole of the third magnet 152a will face the north pole of the second magnet 141a. At this point, the magnetic attraction force between the first magnetic unit 130 and the second magnetic unit 140 will weaken and turn into a magnetic repulsion force, so that the second magnetic unit 140 can be detached from the surface 12 of the load-bearing structure 10 and then complete the detachment of the fixation structure 100.

Furthermore, as shown in FIG. 1, FIG. 6A, FIG. 6B, and FIG. 6C, when the fixation structure 100 is to be detached from the load-bearing structure 10, the third magnetic unit 150 can be pivoted relative to the second magnetic unit 140 first, and then the magnetic pole arrangement can be changed from the strong magnetic state shown in FIG. 6B to the weak magnetic state shown in FIG. 6A. Then, the second device body 120 can be rotated as a whole along the central axis of the fixation structure 100 relative to the first device body 110, so that the second magnets 141 of the second magnetic unit 140 and the third magnets 152 of the third magnetic unit 150 will simultaneously move relative to the first magnetic unit 130. Accordingly, the magnetic pole configuration of the second magnetic unit 140 and the third magnetic unit 150 can be changed from the configuration shown in FIG. 6A to the configuration shown in FIG. 6C, and thus the magnetic force between the first magnetic unit 130 and the second magnetic unit 140 will become repulsive. Consequently, the second device body 120 can be detached from the surface 12 of the load-bearing structure 10 so as to complete the detachment of the fixation structure 100.

In other embodiments, when the fixation structure 100 in the state shown in FIG. 6B is to be detached from the load-bearing structure 10, the second device body 120 can also be rotated as a whole along the central axis of the fixation structure 100 relative to the first device body 110. That is, the second magnet 141 and the third magnet 152a will simultaneously pivot relative to the first magnet 132, so that the second magnet 141a and the third magnet 152 will move and then correspond to the first magnet 132. Consequently, the first device body 110 and the second device body 120 will be separated by the repulsive magnetic force. However, the present disclosure is not limited the detachment method of the fixation structure 100.

Further, when the number of the first magnets 132, the number of the second magnets 141 and the number of the third magnets 152 in the fixation structure 100 are equal, the first magnets 132, the second magnets 141 and the third magnets 152 will automatically align to each other along the central axis of the fixation structure 100 when the first device body 110 and the second device body 120 are magnetically connected. However, the present disclosure is not limited thereto.

Reference is made to FIG. 1, FIG. 2, and FIG. 7 simultaneously. FIG. 7 is a schematic view of the fixation structure 100 shown in FIG. 1 applied to the load-bearing structure 10. As shown in FIG. 1 and FIG. 2, the fixation structure 100 can further include an installation bracket 101 for installing an electronic device 20. In the fixation structure 100, the installation bracket 101 is disposed on the first device body 110, and the installation bracket 101 is away from the load-bearing structure 10. However, it should be noted that the installation bracket 101 can also be disposed on the side of the second device body 120 away from the load-bearing structure 10, and the present disclosure is not limited to the disclosed content.

As shown in FIG. 7, when the first device body 110 is oriented with the first magnetic unit 130 facing the surface 11 of the load-bearing structure 10, and the second device body 120 is oriented with the second magnetic unit 140 facing the surface 12 of the load-bearing structure 10, the first device body 110 and the second device body 120 will be magnetically connected to each other so as to position the fixation structure 100 on the load-bearing structure 10. At this time, the electronic device 20 can be stably installed on the load-bearing structure 10 by the fixation structure 100. Therefore, by the arrangement of the detachable magnetic connection between the first device body 110 and the second device body 120, to respectively position the first device body 110 and the second device body 120 on the two sides of the load-bearing structure 10, the fixation structure 100 of the present disclosure can be positioned on the load-bearing structure 10 without the use of screws, nails or other components that require to be used by the manual or electric tools for installation. Therefore, the installation and removal of the fixation structure 100 of the present disclosure can be simpler and more convenient, and the risk of injury to the user from elements or tools during the installation and removal process can be avoided.

Furthermore, by the arrangements that the first device body 110 includes the first magnetic unit 130, the second device body 120 includes the second magnetic unit 140 and the third magnetic unit 150, and the third magnetic unit 150 can be pivoted relative to the second magnetic unit 140 so as to adjust the magnetic attraction force between the first magnetic unit 130 and the second magnetic unit 140, the magnetic attraction force between the first device body 110 and the second device body 120 of the fixation structure 100 of the present disclosure can be easily adjusted to meet the requirements for positioning, installation, and removal. Therefore, the use of the fixation structure 100 can be more convenient, and it is suitable for repeated assembly and disassembly. Further, the structure of the fixation structure 100 is simple to be easy to mass-produce, the defect rate of the product can be effectively reduced, and the safety issues caused by the structural failure due to aging and other factors can be reduced. Moreover, the screws, the nails and other elements are not needed to the fixation structure 100 to fix the equipment onto the load-bearing structure 10, so that the damage to the load-bearing structure 10 can be avoided, and the overall appearance of the fixation structure 100 will not be affected. Thus, the fixation structure 100 of the present disclosure has excellent market application potential.

As shown in FIG. 1 and FIG. 3, the first device body 110 can further include at least one pad 111, the at least one pad 111 is disposed on the surface (reference number thereof is omitted) of the first device body 110 facing the load-bearing structure 10, and the at least one pad 111 is used to adhere to the surface 11 of the load-bearing structure 10. Specifically, the pad 111 can be made of materials with increased friction or adhesion functions, such as gecko tape, rubber, etc., and can also be made of other materials with suction cup properties, so that the first device body 110 can be pre-positioned on the load-bearing structure 10 before the second device body 120 is positioned so as to facilitate the subsequent installation. Further, the pad 111 can also fill the gap between the first device body 110 and the load-bearing structure 10, making the installation of the fixation structure 100 more stable. Furthermore, the quantity and shape of the pad 111 can be adjusted as needed, and the present disclosure is not limited to the disclosed content.

As shown in FIG. 2 and FIG. 4, the second device body 120 can further include at least one cushioning pad 122, and the cushioning pad 122 is disposed on the surface (reference number thereof is omitted) of the second device body 120 facing the load-bearing structure 10. Specifically, the cushioning pad 122 can be made of shock-absorbing materials with reduced friction, such as rubber, foam, etc., to cushion the force applied to the load-bearing structure 10 when the second device body 120 is installed or operated, and the cushioning pad 122 can also fill the gap between the second device body 120 and the load-bearing structure 10, making the installation of the fixation structure 100 more stable.

As shown in FIG. 1 and FIG. 2, the third magnetic unit 150 can further include a plurality of concave structures 154, which are separately and concavely disposed on an outer side surface (reference number thereof is omitted) of the third magnetic unit 150. The concave structures 154 facilitate the operation of the third magnetic unit 150, allowing it to be pivotally rotated relative to the second magnetic unit 140, making the operation of the fixation structure 100 more convenient. Further, the second magnetic unit 140 can also include concave structures disposed on the outer side surface thereof so as to further enhance the operational convenience of the second device body 120, but the present disclosure is not limited thereto.

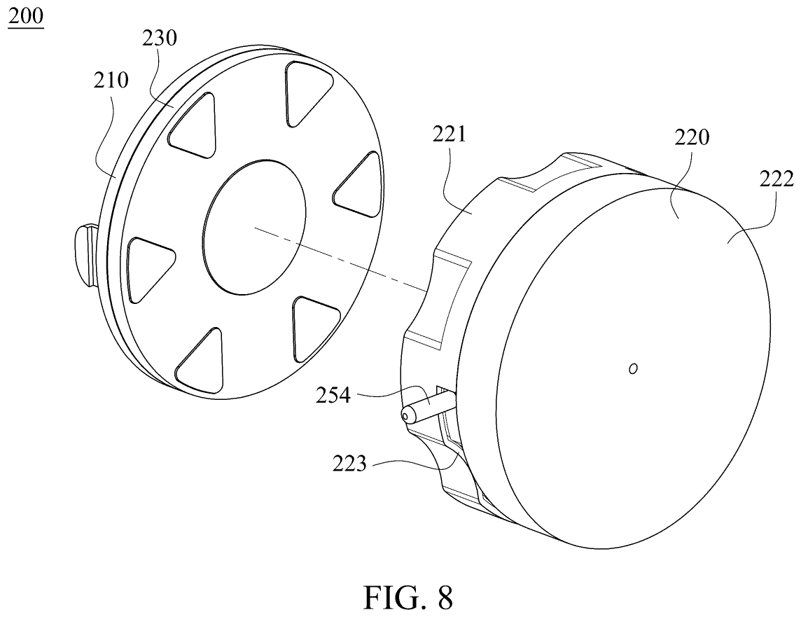

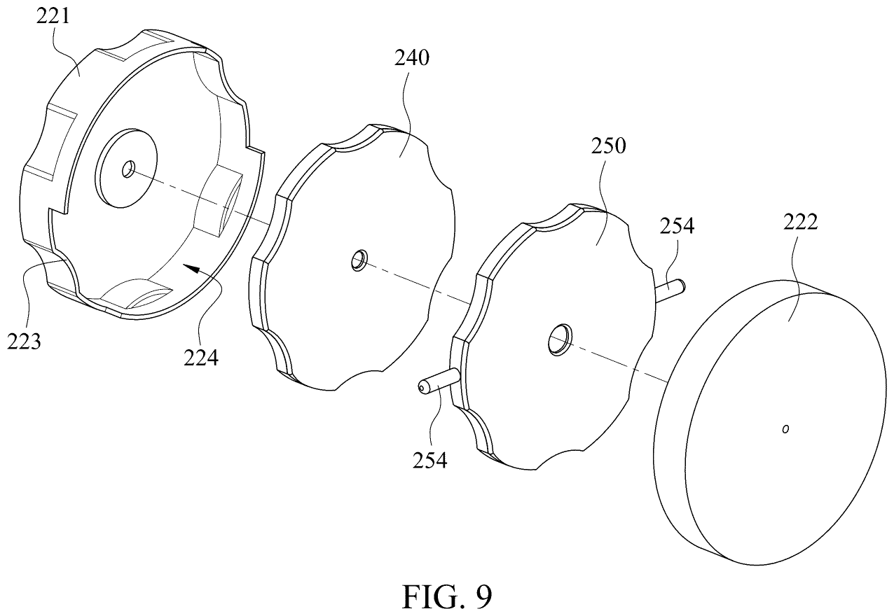

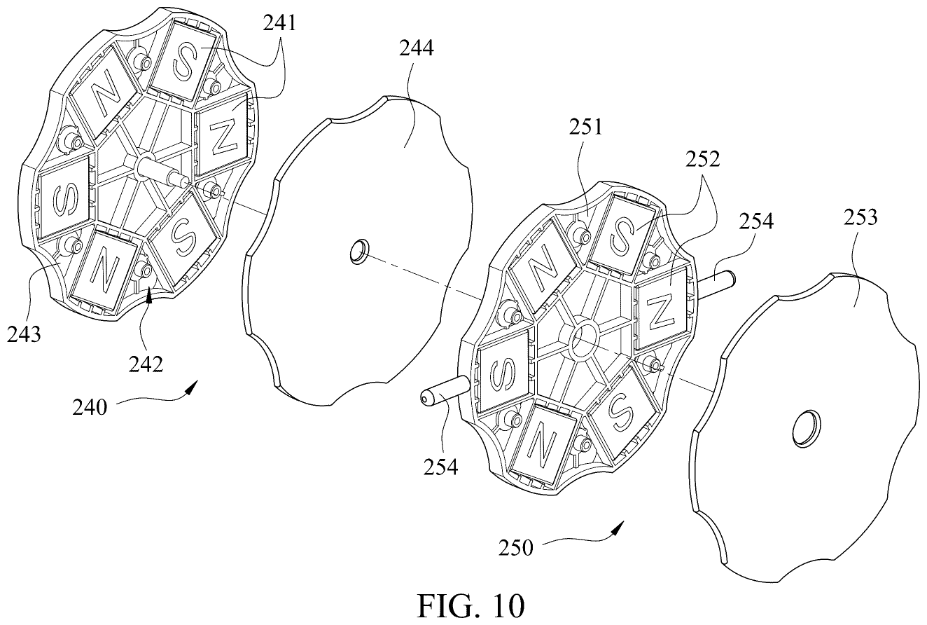

Reference is made to FIG. 8, FIG. 9, and FIG. 10. FIG. 8 is a schematic view of another embodiment of the fixation structure 200 of the present disclosure, FIG. 9 is an exploded view of the second device body 220 of the fixation structure 200 shown in FIG. 8, and FIG. 10 is an exploded view of the second magnetic unit 240 and the third magnetic unit 250 of the second device body 220 shown in FIG. 9. The fixation structure 200 is positioned on a load-bearing structure (not shown) to fix carried objects such as an electronic device (not shown) onto the load-bearing structure. The fixation structure 200 includes a first device body 210 and a second device body 220.

As shown in FIG. 8, FIG. 9, and FIG. 10, the first device body 210 is detachably and magnetically connected to the second device body 220. The first device body 210 includes a first magnetic unit 230, and the second device body 220 includes a carrier body 221, a casing 222, a second magnetic unit 240, a third magnetic unit 250 and an adjustment member 254. Further, the first device body 210 and the first magnetic unit 230 are structurally similar to the first device body 110 and the first magnetic unit 130 of the fixation structure 100, respectively, and thus the details of the same structures will not be described herein.

The carrier body 221 includes a guiding slot 223. The casing 222 is coupled to the carrier body 221, an accommodation space 224 is defined by the casing 222 and the carrier body 221, and the second magnetic unit 240 and the third magnetic unit 250 are accommodated in the accommodation space 224.

The second magnetic unit 240 includes at least two second magnets 241, and the at least two second magnets 241 are disposed in an inner space 242 of the second magnetic unit 240. Furthermore, the second magnetic unit 240 can include an installation disc 243 and a first cover element 244, and the installation disc 243 and the first cover element 244 are coupled to each other to define the inner space 242. The second magnets 241 are fixedly arranged on the installation disc 243 and located in the inner space 242.

The third magnetic unit 250 abuts the second magnetic unit 240, the third magnetic unit 250 includes a carrier plate 251 and at least one third magnet 252, and the at least one third magnet 252 is disposed on the carrier plate 251. Further, the third magnetic unit 250 can further include a second cover 253. The carrier plate 251 and the second cover 253 are coupled to each other, and the third magnet 252 is fixedly arranged on the carrier plate 251. Furthermore, the adjustment member 254 is fixedly disposed on the third magnetic unit 250 and protrudes from the accommodation space 224. The adjustment member 254 can be movably engaged in the guiding slot 223. When it is desired to adjust the third magnetic unit 250 to pivot relative to the second magnetic unit 240, the adjustment member 254 can be moved within the guiding slot 223. At this time, the adjustment member 254 will drive the third magnetic unit 250 to pivot so as to adjust the magnetic attraction force between the first magnetic unit 230 and the second magnetic unit 240 by changing the magnetic poles of the third magnetic unit 250 relative to the second magnetic unit 240.

Therefore, by the arrangements of the inclusion of the carrier body 221 and the casing 222 in the second device body 220, and the adjustment member 254 being movably engaged in the guiding slot 223 of the carrier body 221, the adjustment of the magnetic attraction force of the fixation structure 200 of the present disclosure becomes simpler, and the pivoting degree of the third magnetic unit 250 relative to the second magnetic unit 240 can be limited by the corresponding arrangement of the guiding slot 223 and the adjustment member 254, so that the operation of the fixation structure 200 can be more effective and convenient.

Further, the method for adjusting the magnetic attraction force of the fixation structure 200 is the same as that of the fixation structure 100. The arrangements of the magnetic poles of the first magnet (not shown) of the first magnetic unit 230, the second magnets 241 and the third magnets 252 to be the strong magnetic state, the weak magnetic state or the magnetic attraction force release between the first device body 210 and the second device body 220 are also the same as that of the fixation structure 100, and thus the details will not be described herein.

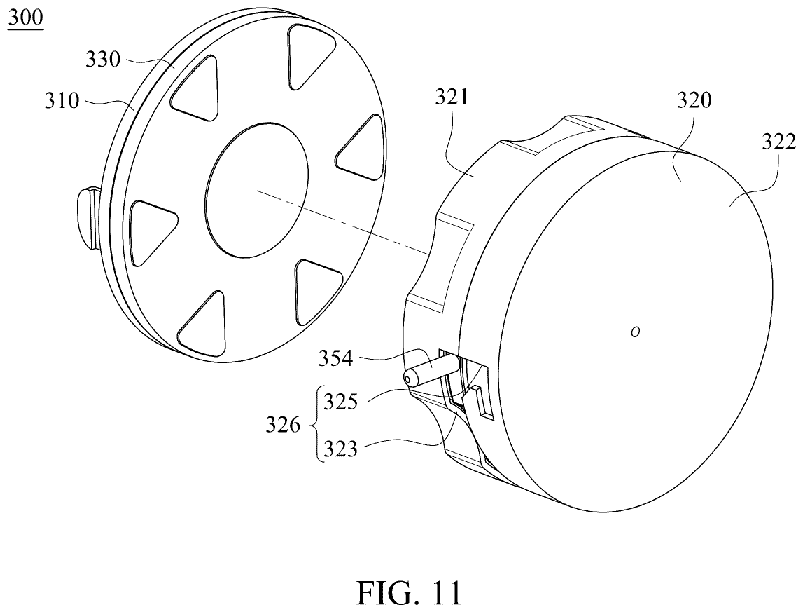

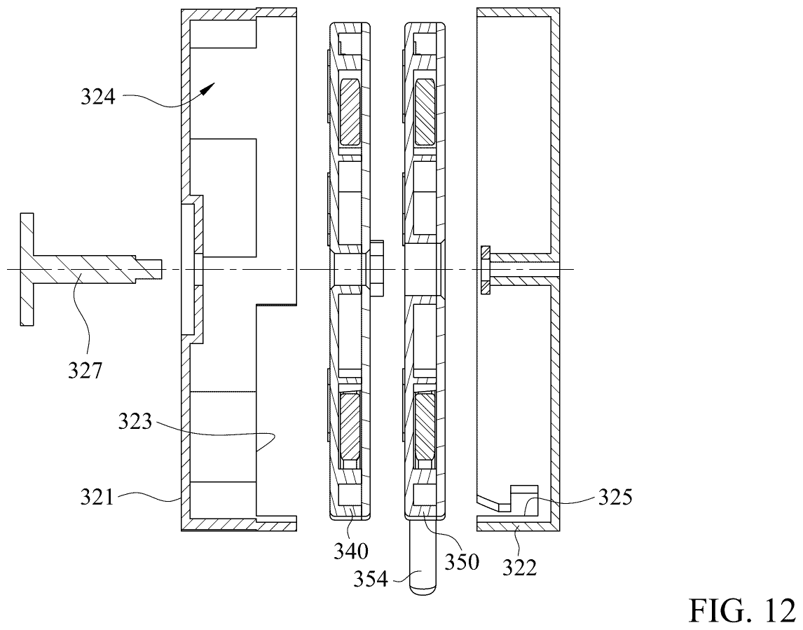

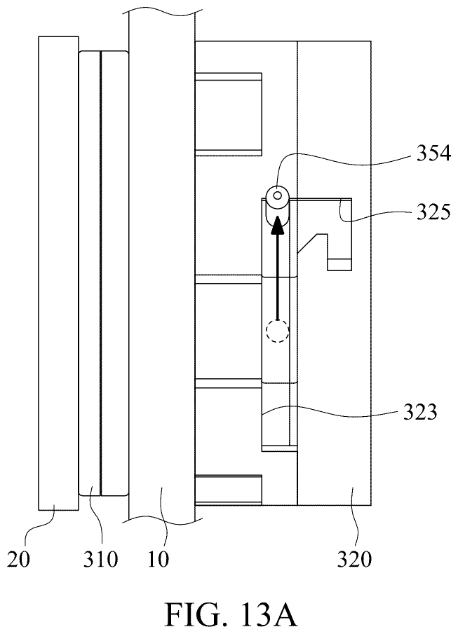

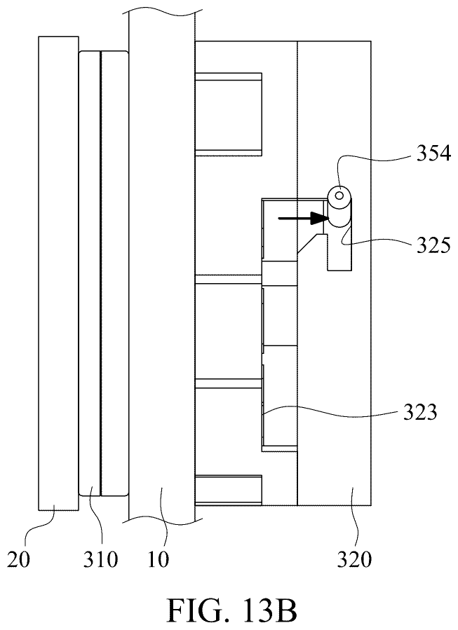

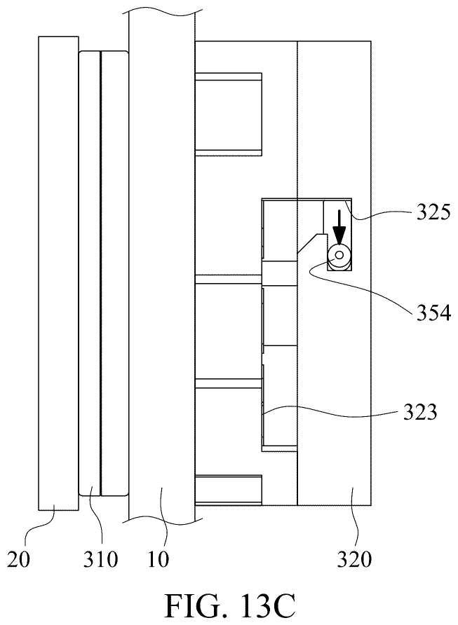

Reference is made to FIG. 11 and FIG. 12. FIG. 11 is a schematic view of yet another embodiment of a fixation structure 300 of the present disclosure, and FIG. 12 is an exploded view of the second device body 320 of the fixation structure 300 shown in FIG. 11. The fixation structure 300 is positioned on a load-bearing structure 10 (shown in FIG. 13A to FIG. 13C) to fix carried objects such as an electronic device 20 (shown in FIG. 13A to FIG. 13C) onto the load-bearing structure 10. The load-bearing structure 10 can be a structure with open spaces on both sides, such as panels, walls, windows, or columns. The fixation structure 300 includes a first device body 310 and a second device body 320.

The first device body 310 is detachably and magnetically connected to the second device body 320. The first device body 310 includes a first magnetic unit 330, and the second device body 320 includes a carrier body 321, a casing 322, a second magnetic unit 340, a third magnetic unit 350 and an adjustment member 354. Further, the first device body 310 and the first magnetic unit 330 are structurally similar to the first device body 110 and the first magnetic unit 130 of the fixation structure 100, respectively, and thus the details of the same structures will not be described herein.

The carrier body 321 includes a guiding slot 323. The casing 322 is coupled to the carrier body 321 and includes an engaging slot 325. An accommodation space 324 is defined by the casing 322 and the carrier body 321, and the guiding slot 323 and the engaging slot 325 are communicated with each other so as to form an adjustment structure 326.

The second magnetic unit 340 is disposed on the carrier body 321 and located in the accommodation space 324, and the second magnetic unit 340 is detachably and magnetically connected to the first magnetic unit 330. Further, the second magnetic unit 340 and the second magnetic unit 140 of the fixation structure 100 are structurally similar, and thus the details of the same structures will not be described herein.

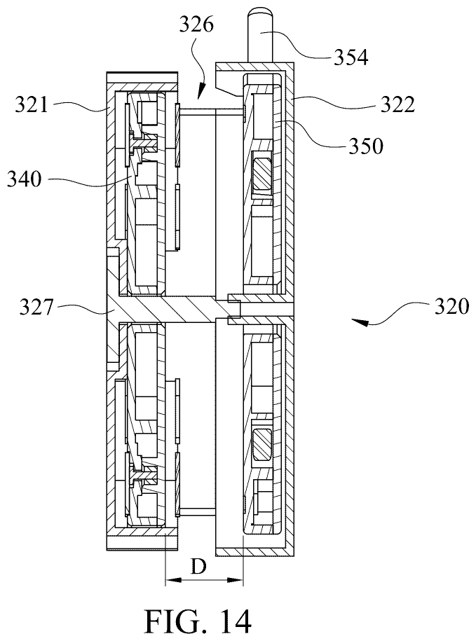

The third magnetic unit 350 is pivotally disposed on the second magnetic unit 340 and located in the accommodation space 324. The second magnetic unit 340 is positioned between the first device body 310 and the third magnetic unit 350, and there is a component gap D between the second magnetic unit 340 and the third magnetic unit 350 (as shown in FIG. 14). The adjustment member 354 is fixedly disposed on the third magnetic unit 350, and the adjustment member 354 protrudes from the accommodation space 324 and can be movably engaged in the adjustment structure 326. Further, the third magnetic unit 350 is structurally similar to the third magnetic unit 150 of the fixation structure 100, and thus the details of the same structures will not be described herein.

Specifically, the carrier body 321, the second magnetic unit 340, the third magnetic unit 350 and the casing 322 are installed by a connecting member 327, so that the second magnetic unit 340 and the third magnetic unit 350 are disposed in the accommodation space 324 formed by the casing 322 and the carrier body 321. Since the adjustment member 354 is fixed on the third magnetic unit 350, and the adjustment member 354 is engaged in the adjustment structure 326, the third magnetic unit 350 and the second magnetic unit 340 will not contact to each other, and the component gap D can be formed there between. Thus, the friction between the third magnetic unit 350 and the second magnetic unit 340 can be avoided when pivoting relative to each other, and the use of the fixation structure 300 can be more convenient.

Reference is made to FIG. 12, FIG. 13A, FIG. 13B, FIG. 13C, and FIG. 14. FIG. 13A is an operational schematic view of the fixation structure 300 shown in FIG. 11 applied to a load-bearing structure 10, FIG. 13B is another operational schematic view of the fixation structure 300 shown in FIG. 11 to a load-bearing structure 10 applied, FIG. 13C is yet another operational schematic view of the fixation structure 300 shown in FIG. 11 applied to a load-bearing structure 10, and FIG. 14 is a cross-sectional view of the second device body 320 of the fixation structure 300 shown in FIG. 13C.

As shown in FIG. 13A, when the adjustment member 354 is positioned in the guiding slot 323, the component gap D between the second magnetic unit 340 and the third magnetic unit 350 is smallest. At this time, the adjustment member 354 can be moved, and the adjustment member 354 will move within the guiding slot 323. The adjustment member 354 fixed on the third magnetic unit 350 will drive the third magnetic unit 350 to pivot relative to the second magnetic unit 340 so as to adjust the magnetic attraction force between the first device body 310 and the second device body 320, and the fixation structure 300 can be positioned on the load-bearing structure 10 with the electronic device 20 installed thereon. When the adjustment member 354 is positioned at the dotted line location shown in FIG. 13A, the magnetic attraction force between the first device body 310 and the second device body 320 is in a strong magnetic state. When the adjustment member 354 is positioned on the side of the guiding slot 323 close to the engaging slot 325, the magnetic attraction force between the first device body 310 and the second device body 320 will turn to a weak magnetic state.

As shown in FIG. 13B, when the fixation structure 300 is to be detached from the load-bearing structure 10, the adjustment member 354 will first be moved to the position shown in FIG. 13A so as to position the adjustment member 354 on the side of the guiding slot 323 close to the engaging slot 325. At this time, the magnetic attraction force between the first device body 310 and the second device body 320 is in a weak magnetic state, and the third magnetic unit 350 will automatically move away from the second magnetic unit 340 due to the repulsion force from the second magnetic unit 340 (refer to the magnetic pole arrangement shown in FIG. 6C), so that the size of the component gap D is increased. This will further drive the adjustment member 354 into the engaging slot 325.

Next, as shown in FIG. 13C and FIG. 14, after the adjustment member 354 enters the engaging slot 325, the adjustment member 354 can further move within the engaging slot 325 so as to drive the third magnetic unit 350 to pivot relative to the second magnetic unit 340 and then be positioned at the end portion of the engaging slot 325, so that the adjustment member 354 can be prevented from being displaced due to external forces or magnetic forces. Accordingly, the magnetic attraction force between the first magnetic unit 330 and the second magnetic unit 340 can be maintained in a weak magnetic state, and it is favorable for the detachment of the second magnetic unit 340 from the load-bearing structure 10 and completing the removal of the fixation structure 300.

Furthermore, the adjustment structure 326 can present a C-shaped structure in appearance, and it is favorable for the movement of the adjustment member 354 within the guiding slot 323 and the engaging slot 325. However, the present disclosure is not limited to the disclosed content. Further, the arrangements of the magnetic poles of the first magnet (not shown), the second magnet (not shown) and the third magnet (not shown) of the first device body 310 and the second device body 320 to be the magnetic attraction force in the strong magnetic states, the weak magnetic states or releasing the magnetic attraction force are similar to those of the fixation structure 100, and thus the details of the same structures will not be described herein.

In view of the above, the fixation structure of the present disclosure has the advantages of safety, convenience, and universality, and is beneficial for production and manufacturing. At the same time, the need for screws, nails, and other elements that require manual or electric tools for installation can be omitted, and thus the fixation structure of the present disclosure has excellent market application potential.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A fixation structure, comprising:
a first device body, comprising;
a first magnetic unit; and
a second device body detachably and magnetically connected to the first device body, the second device body comprising:
a second magnetic unit detachably and magnetically connected to the first magnetic unit; and
a third magnetic unit pivotally disposed on the second magnetic unit, wherein the second magnetic unit and the third magnetic unit abut against each other, and the second magnetic unit is located between the first device body and the third magnetic unit;
wherein the first device body is oriented with the first magnetic unit facing a surface of a load-bearing structure, and the second device body is oriented with the second magnetic unit facing another surface opposite the surface of the load-bearing structure, so that the first device body and the second device body are respectively positioned on two sides of the load-bearing structure, and a magnetic attraction force is generated between the first magnetic unit and the second magnetic unit to magnetically connect the first device body to the second device body so as to position the fixation structure on the load-bearing structure;
wherein the third magnetic unit is pivoted relative to the second magnetic unit so as to adjust the magnetic attraction force between the first magnetic unit and the second magnetic unit.

2. The fixation structure of claim 1, wherein the first magnetic unit comprises:
a housing having an internal space; and
at least two first magnets disposed in the internal space, and the at least two first magnets being separated from each other and arranged around a central point of the first device body;
wherein a magnetic pole of each of the at least two first magnets is positioned proximately to the surface of the load-bearing structure, another magnetic pole of each of the at least two first magnets is positioned distally to the surface of the load-bearing structure, and the at least two first magnets are configured in an alternating arrangement of north (N) poles and south (S) poles.

3. The fixation structure of claim 1, wherein:
the second magnetic unit comprises at least two second magnets, the at least two second magnets are disposed in an inner space of the second magnetic unit, and the at least two second magnets are separated from each other and arranged around a central point of the second device body; and
a magnetic pole of each of the at least two second magnets is positioned proximately to the another surface of the load-bearing structure, another magnetic pole of each of the at least two second magnets is positioned distally to the another surface of the load-bearing structure, and the at least two second magnets are configured in an alternating arrangement of north poles and south poles.

4. The fixation structure of claim 3, wherein the third magnetic unit comprises:
a carrier plate; and
at least one third magnet disposed on the carrier plate;
wherein a magnetic pole of the at least one third magnet is positioned proximately to the second magnetic unit, and another magnetic pole of the at least one third magnet is positioned distally to the second magnetic unit.

5. The fixation structure of claim 4, wherein:
a number of the at least one third magnet is at least two, and the at least two third magnets are configured with the north poles thereof proximate to the second magnetic unit, with the south poles thereof proximate to the second magnetic unit, or with the north poles and the south poles thereof arranged alternately; and
the third magnetic unit is pivoted relative to the second magnetic unit to adjust a relative position of the at least two third magnets and the at least two second magnets, and when one of the at least two third magnets and one of the at least two second magnets attract each other, the magnetic attraction force between the first magnetic unit and the second magnetic unit is enhanced.

6. The fixation structure of claim 1, wherein the first device body further comprises:
at least one pad disposed on a surface of the first device body facing the load-bearing structure and for adhering to the surface of the load-bearing structure.

7. The fixation structure of claim 1, wherein the second device body further comprises:
at least one cushioning pad disposed on a surface of the second device body facing the load-bearing structure.

8. The fixation structure of claim 1, further comprising:
an installation bracket for installing an electronic device, wherein the installation bracket is disposed on at least one of the first device body and the second device body, and the installation bracket is away from the load-bearing structure.

9. The fixation structure of claim 1, wherein the second device body further comprises:
at least one sliding block disposed on one of the second magnetic unit and the third magnetic unit; and
at least one restricting slot disposed on another one of the second magnetic unit and the third magnetic unit, and the at least one sliding block is correspondingly disposed in the at least one restricting slot.

10. The fixation structure of claim 1, wherein the second device body further comprises:
a carrier body comprising a guiding slot;
a casing coupled to the carrier body, wherein an accommodation space is defined by the casing and the carrier body, and the second magnetic unit and the third magnetic unit are disposed in the accommodation space; and
an adjustment member fixed on the third magnetic unit, wherein the adjustment member protrudes from the accommodation space and is movably engaged in the guiding slot;
wherein when the adjustment member moves in the guiding slot, the third magnetic unit is pivoted relative to the second magnetic unit.

11. A fixation structure, comprising:
a first device body, comprising;
a first magnetic unit; and
a second device body detachably and magnetically connected to the first device body, the second device body comprising:
a carrier body comprising a guiding slot;
a casing coupled to the carrier body and comprising an engaging slot, wherein an accommodation space is defined by the casing and the carrier body, and the guiding slot and the engaging slot are communicated with each other so as to form an adjustment structure;
a second magnetic unit disposed on the carrier body and located in the accommodation space, and the second magnetic unit being detachably and magnetically connected to the first magnetic unit;
a third magnetic unit pivotally disposed on the second magnetic unit and located in the accommodation space, wherein the second magnetic unit is located between the first device body and the third magnetic unit, and there is a component gap between the second magnetic unit and the third magnetic unit; and
an adjustment member fixed on the third magnetic unit, wherein the adjustment member protrudes from the accommodation space and is movably engaged in the adjustment structure;
wherein the first device body is oriented with the first magnetic unit facing a surface of a load-bearing structure, and the second device body is oriented with the second magnetic unit facing another surface opposite the surface of the load-bearing structure, so that the first device body and the second device body are respectively positioned on two sides of the load-bearing structure, and a magnetic attraction force is generated between the first magnetic unit and the second magnetic unit to magnetically connect the first device body to the second device body so as to position the fixation structure on the load-bearing structure;
wherein when the adjustment member moves in the adjustment structure, the third magnetic unit moves relative to the second magnetic unit so as to adjust the magnetic attraction force between the first magnetic unit and the second magnetic unit.

12. The fixation structure of claim 11, wherein the first magnetic unit comprises:
a housing having an internal space; and
at least two first magnets disposed in the internal space, and the at least two first magnets being separated from each other and arranged around a central point of the first device body;
wherein a magnetic pole of each of the at least two first magnets is positioned proximately to the surface of the load-bearing structure, another magnetic pole of each of the at least two first magnets is positioned distally to the surface of the load-bearing structure, and the at least two first magnets are configured in an alternating arrangement of north poles and south poles.

13. The fixation structure of claim 11, wherein:
the second magnetic unit comprises at least two second magnets, the at least two second magnets are disposed in an inner space of the second magnetic unit, and the at least two second magnets are separated from each other and arranged around a central point of the second device body; and
a magnetic pole of each of the at least two second magnets is positioned proximately to the another surface of the load-bearing structure, another magnetic pole of each of the at least two second magnets is positioned distally to the another surface of the load-bearing structure, and the at least two second magnets are configured in an alternating arrangement of north poles and south poles.

14. The fixation structure of claim 13, wherein the third magnetic unit comprises:
a carrier plate; and
at least one third magnet disposed on the carrier plate;
wherein a magnetic pole of the at least one third magnet is positioned proximately to the second magnetic unit, and another magnetic pole of the at least one third magnet is positioned distally to the second magnetic unit.

15. The fixation structure of claim 14, wherein:
a number of the at least one third magnet is at least two, and the at least two third magnets are configured with the north poles thereof proximate to the second magnetic unit, with the south poles thereof proximate to the second magnetic unit, or with the north poles and the south poles thereof arranged alternately; and
the third magnetic unit pivots relative to the second magnetic unit to adjust a relative position of the at least two third magnets and the at least two second magnets, and when one of the at least two third magnets and one of the at least two second magnets attract each other, the magnetic attraction force between the first magnetic unit and the second magnetic unit is enhanced.

16. The fixation structure of claim 14, wherein:
the adjustment member moves in the adjustment structure and enters the guiding slot or the engaging slot, so that the third magnetic unit presents a first position or a second position relative to the second magnetic unit;
when the adjustment member enters the guiding slot, the third magnetic unit presents the first position relative to the second magnetic unit; and
when the adjustment member moves from the guiding slot and then enters the engaging slot, the third magnetic unit moves into the casing, the third magnetic unit presents the second position relative to the second magnetic unit, and the third magnetic unit is away from the second magnetic unit.

17. The fixation structure of claim 11, wherein the first device body further comprises:
at least one pad disposed on a surface of the first device body facing the load-bearing structure and for adhering to the surface of the load-bearing structure.

18. The fixation structure of claim 11, wherein the second device body further comprises:
at least one cushioning pad disposed on at least one of a surface of the second magnetic unit facing the load-bearing structure and a surface of the third magnetic unit facing the load-bearing structure.

19. The fixation structure of claim 11, further comprising:
an installation bracket for installing an electronic device, wherein the installation bracket is disposed on at least one of the first device body and the second device body, and the installation bracket is away from the load-bearing structure.

20. The fixation structure of claim 11, wherein the second device body further comprises:
at least one sliding block disposed on one of the second magnetic unit and the third magnetic unit; and
at least one restricting slot disposed on another one of the second magnetic unit and the third magnetic unit, and the at least one sliding block is correspondingly disposed in the at least one restricting slot.
